(19) United States
(12) Patent Application Publication
(10) Pub. No.: US 2024/0091881 A1
(43) Pub. Date: Mar. 21, 2024

(54) WELDMENT MANUFACTURING METHOD, WELDMENT, AND WELDMENT REPAIRING METHOD

(71) Applicant: MITSUBISHI HEAVY INDUSTRIES, LTD., Tokyo (JP)

(72) Inventors: Yasutaka Banno, Tokyo (JP); Yasuyuki Fujiya, Tokyo (JP); Shuho Tsubota, Tokyo (JP); Masahiro Kimura, Tokyo (JP); Tomoyuki Nishiyama, Tokyo (JP)

(73) Assignee: MITSUBISHI HEAVY INDUSTRIES, LTD., Tokyo (JP)

(21) Appl. No.: 18/263,776

(22) PCT Filed: Feb. 7, 2022
(86) PCT No.: PCT/JP2022/004693

§ 371 Date: Aug. 1, 2023

(30) Foreign Application Priority Data
Feb. 10, 2021 (JP) 2021-020147

(51) Int. Cl. B23K 26/21; B23K 26/38; B23K 33/00

(52) U.S. Cl. CPC B23K 26/21; B23K 26/38; B23K 33/00

(57) ABSTRACT

A weldment manufacturing method includes a recess forming step of forming recesses on a first target member and a second target member, the recesses delineating holes each of which spans across the first target member and the second target member and that are arranged along a boundary between the first target member and the second target member when the first and second target members that are the objects to be welded together are brought into abutment against each other; an abutting step of bringing the first and second target members into abutment against each other by aligning the recesses so that the recesses delineate the respective holes; and a welding step of placing filler material in the respective holes irradiating and scanning the filler material with the laser to cause the filler material to melt so as to fill the holes with the molten filler material.

### FIELD

The present disclosure relates to a weldment manufacturing method, a weldment, and a weldment repairing method.

### BACKGROUND

As an example of a welding technique for joining hot rolled steel sheets, narrow gap laser welding has been known (see Patent Literature 1, for example). In such narrow gap laser welding, thick steel sheets are arranged side by side, with a slight gap (groove) therebetween. Filler material, such as wire, is then supplied into the gap, and weld is formed by irradiating the filler material with a laser and causing the wire to melt, and the weld is laid in layers in the depth direction of the gap.

### CITATION LIST

### Patent Literature

Patent Literature 1: Japanese Patent Application Laid-open No. 2015-178130

### SUMMARY

### Technical Problem

In the narrow gap laser welding described above, because a groove needs to be ensured between the hot-rolled steel sheets, filler material, once melts, makes welding deformation, such as angular distortion, traverse shrinkage, and longitudinal shrinkage, more prominent.

At least one embodiment of the present disclosure is made in consideration of the situation described above, and an object of this embodiment is to provide a weldment manufacturing method and a weldment capable of suppressing such welding deformation.

### Solution to Problem

A weldment manufacturing method according to the present disclosure includes the steps of: forming recesses on a first target member and a second target member, the recesses delineating a plurality of holes each of which spans across the first target member and the second target member and that are arranged along a boundary between the first target member and the second target member when the first target member and the second target member that are objects to be welded together are brought into abutment against each other; bringing the first target member and the second target member into abutment against each other by aligning the recesses so that the recesses delineate the plurality of holes; and forming welds by placing filler material in the plurality of holes and irradiating and scanning the filler material with laser to cause the filler material to melt so as to fill the holes with the molten filler material.

A weldment manufacturing method according to the present disclosure includes: a first target member and a second target member; and a weld that joins the first target member to the second target member. The first target member and the second target member are in abutment against each other so that a plurality of holes each of which spans across the first target member and the second target member and that are arranged along a boundary between the first target member and the second target member are delineated. The weld is disposed so as to fill the plurality of holes.

A weldment includes: a first target member and a second target member; and a weld that joins the first target member to the second target member. The first target member and the second target member are in abutment against each other so that a plurality of holes each of which spans across the first target member and the second target member and that are arranged along a boundary between the first target member and the second target member are delineated. The weld is disposed so as to fill the plurality of holes.

A weldment repairing method according to the present disclosure includes the steps of: forming a repair hole in the weld of the above-described weldment; and forming a welding repaired portion by placing filler material inside the repair hole, irradiating and scanning the filler material with laser to cause the filler material to melt so as to fill the repair hole with the molten filler material.

### Advantageous Effects of Invention

According to at least one embodiment of the present disclosure, it is possible to provide a weldment manufacturing method and a weldment capable of suppressing welding deformation.

### BRIEF DESCRIPTION OF DRAWINGS

FIG. 1 is a schematic illustrating a general configuration of a welding system according to a first embodiment.

FIG. 2 is a flowchart illustrating an example of a weldment manufacturing method according to this embodiment.

FIG. 3 is a process chart illustrating steps included in the weldment manufacturing method according to this embodiment.

FIG. 4 is a process chart illustrating the steps included in the weldment manufacturing method according to this embodiment.

FIG. 5 is a schematic illustrating a structure of a cross-section across the line A-A in FIG. 3 (ST3).

FIG. 6 is a schematic illustrating a structure of a cross-section across the line A-A in FIG. 3 (ST3).

FIG. 7 is a schematic for explaining an example of a trajectory along which the laser is scanned.

FIG. 8 is a schematic for explaining an example of the trajectory along which the laser is scanned.

FIG. 9 is a schematic for explaining an example of the trajectory along which the laser is scanned.

FIG. 10 is a flowchart illustrating an example of a weldment manufacturing method according to a second embodiment.

FIG. 11 is a process chart illustrating steps included in the weldment manufacturing method according to this embodiment.

FIG. 12 is a process chart illustrating the steps included in the weldment manufacturing method according to this embodiment.

FIG. 13 is a schematic illustrating an example of a weldment manufacturing method according to a third embodiment.

FIG. 14 is a schematic illustrating an example of a weldment manufacturing method according to a fourth embodiment.

FIG. 15 is a schematic illustrating an example of a weldment according to a modification.

FIG. 16 is a schematic illustrating an example of a weldment manufacturing method according to a modification.

FIG. 17 is a schematic illustrating an example of a weldment manufacturing method according to a modification.

FIG. 18 is a schematic illustrating examples of weldment manufacturing methods according to some modifications.

FIG. 19 is a schematic illustrating an example of weldment repairing method according to the present disclosure.

### DESCRIPTION OF EMBODIMENTS

Some embodiments of a weldment manufacturing method and a weldment according to the present disclosure will now be explained with reference to some drawings. These embodiments are, however, not intended to limit the scope of the present invention in any way. Elements to be described below in the embodiments include those that are replaceable or easily replaceable by those skilled in the art, or those that are substantially the same.

### First Embodiment

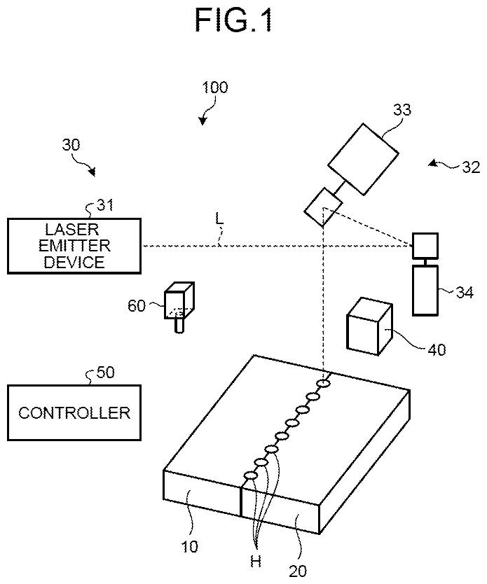

FIG. 1 is a schematic illustrating a general configuration of a welding system according to a first embodiment. This welding system 100 welds a first target member 10 and a second target member 20 that are objects to be welded together. The first target member 10 and the second target member 20 are metal materials, for example, and hot-rolled steel sheets having a thickness equal to or more than 100 mm are used. As illustrated in FIG. 1, the welding system 100 includes a laser processing machine 30, a filler material feeder 40, and a controller 50. The welding system 100 may include a fixing mechanism that fixes the first target member 10 and the second target member 20, and a moving mechanism that adjusts relative positions of the first target member 10 and the second target member 20, with respect to each of the devices described above.

The laser processing machine 30 includes a laser emitter device 31 and a laser scanner device 32. The laser emitter device 31 outputs laser. As the laser emitter device 31, a fiber laser output device or a short-pulse laser output device may be used. As the fiber laser output device, a Fabry-Perot fiber laser output device or a ring fiber laser output device may be used, for example. By exciting these output devices, laser becomes excited. For the fiber used in the fiber laser output device, silica glass doped with a rare-earth element such as erbium (Er), neodymium (Nd), or ytterbium (Yb) may be used. In this embodiment, as a fiber laser (first laser) L1, pulsed laser such as a YAG laser or a YVO4 laser the oscillation of which is in the order of microseconds or less may be used. As a laser oscillation source of the short-pulse laser output device, a titanium sapphire laser may be used. The short-pulse laser output device can oscillate a pulse at a pulse width of 100 picoseconds or smaller, for example. In this embodiment, the short-pulse laser outputs short-pulse laser having a pulse width of 100 microseconds or smaller. A laser processing unit 22 preferably uses a short pulse having a pulse width of 100 nanoseconds or smaller, and more preferably a laser having a pulse width smaller than 1 nanosecond, as a short-pulse laser L2.

The laser emitter device 31 preferably outputs laser of 0.5 kW or higher and 10 kW or lower, and more preferably outputs laser 3 kW or higher and 9 kW or lower. The laser emitter device 31 preferably emits laser having a beam diameter of 0.6 mm or larger and 1.6 mm or smaller.

Among high-power lasers, the laser emitter device 31 may be a single-mode laser having a smaller laser diameter so that scanning pattern can be controlled more precisely, for example, or may be multi-mode laser.

The laser scanner device 32 scans the laser emitted from the laser emitter device 31 to irradiate holes H therewith. The laser scanner device 32 includes a first Galvano mirror 33 and a second Galvano mirror 34. The first Galvano mirror 33 and the second Galvano mirror 34 change angles of their respective mirrors so as to change the direction toward which the laser emitted from the laser emitter device 31 is reflected. By making the directions in which the respective mirrors of the first Galvano mirror 33 and the second Galvano mirror 34 are rotated different, the laser scanner device 32 changes the position irradiated with the laser across a two-dimensional plane on the weldment 30. The laser scanner device 32 preferably scan the laser at 1 m/sec or higher or 10 m/sec.

When a pulsed laser is used, the laser processing machine 30 scans the laser at an interval of 1 mm or less. The time by which the laser is emitted is preferably 1 second or longer and 30 seconds or shorter, and is more preferably 5 seconds or longer and 21 seconds or shorter.

Any laser processing machine capable of scanning the laser emitted thereby may be used as the laser processing machine 30. For example, the laser processing machine 30 may have an arrangement of a plurality of laser elements emitting laser, and switch the laser elements emitting the laser so that the position being irradiated with the laser is scanned.

The filler material feeder 40 fills the holes H that are formed when the first target member 10 and the second target member 20 are brought into abutment against each other, with filler material having a predetermined size corresponding to the holes H. As filler material, at least one of a member that is a cut wire member, powder, base material on a block may be used. As the filler material, a linear wire may be fed continuously. The filler material feeder 40 may have a plurality of types of filler material, each type of which has a predetermined size, or filler material may be cut into a predetermined size.

The controller 50 controls the operations of the units included in the welding system 100. The controller 50 includes a processor such as a central processing unit (CPU), and a memory such as random-access memory (RAM) or read-only memory (ROM). The controller 50 also stores therein data, computer programs, and the like for controlling the operations of the laser processing machine 30 and the filler material feeder 40.

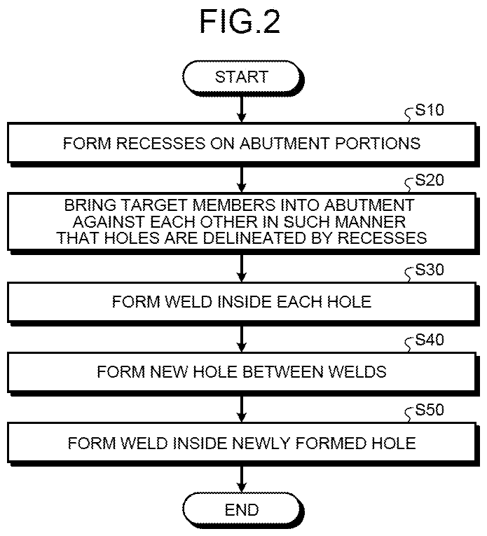

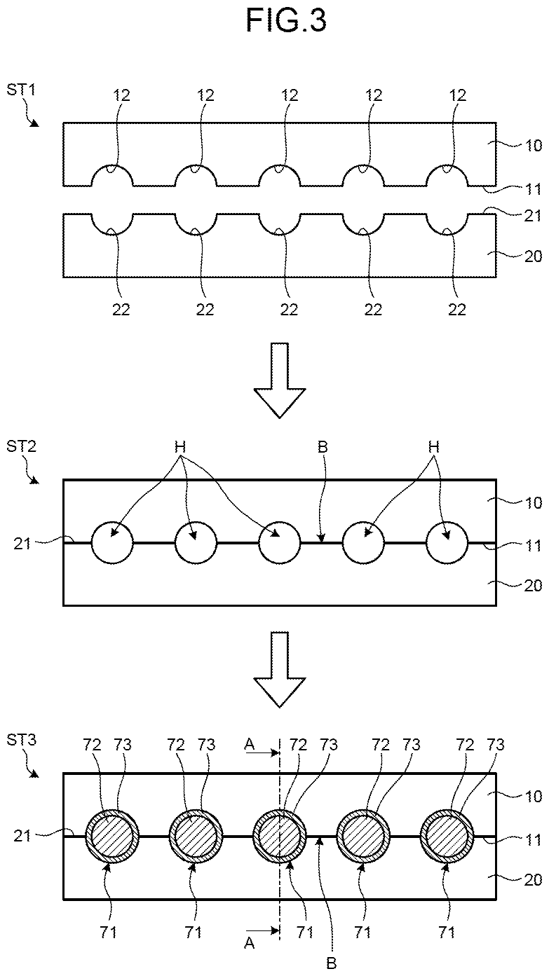

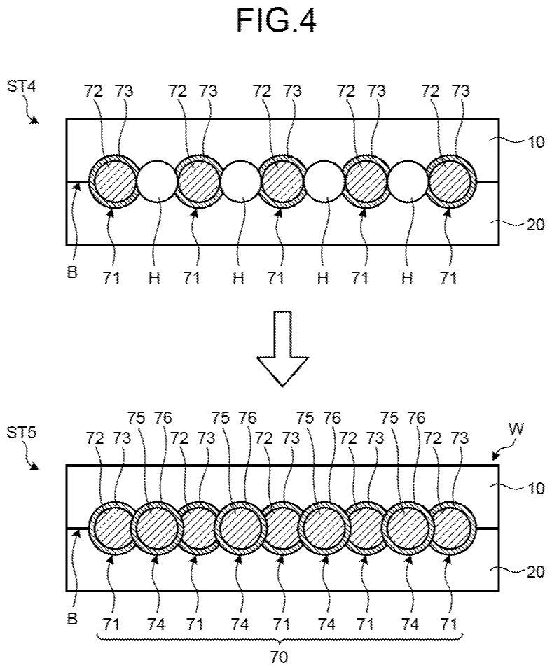

One example of a weldment manufacturing method according to this embodiment will now be explained. FIG. 2 is a flowchart illustrating an example of the weldment manufacturing method according to this embodiment. FIGS. 3 and 4 are process charts illustrating steps included in the weldment manufacturing method according to this embodiment.

To begin with, as illustrated in FIG. 3 (ST1), recesses 12 are formed on the abutment portion 11 of the first target member 10, and recesses 22 are formed on the abutment portion 12 of the second target member 20 (S10: recess forming step). At the recess forming step, the recesses 12, 22 are formed so as to delineate a plurality of holes when the first target member 10 and the second target member 20 that are objects to be welded are brought into abutment, the plurality of holes being holes each of which spans across the first target member 10 and the second target member 20, and that are aligned along a boundary B (see ST2 in FIG. 3, for example) between the first target member 10 and the second target member 20. The recesses 11, 12 may be mechanically formed using a hole forming apparatus 60, for example.

As illustrated in FIG. 3 (ST2), the first target member 10 and the second target member 20 are then brought into abutment against each other (S20: abutting step). At the abutting step, the first target member 10 and the second target member 20 are aligned and brought into abutment against each other in such a manner that a plurality of holes H spanning across the first target member 10 and the second target member 20 are delineated by the recesses 12, 22, which have been formed at the recess forming step.

At the recess forming step, the recesses 12, 22 may be formed in such a manner that each of the holes H has a diameter of 5 mm or so, and a depth of 100 mm or so (that is, at an aspect ratio of 1:20 or so), and that the interval between the holes H is 10 mm or so. In this embodiment, because the holes H are pass-through holes, the depth of the holes H is the same as the thicknesses of the first target member 10 and the second target member 20. The dimensions of the holes H are, however, not limited to the examples described above.

As illustrated in FIG. 3 (ST3), a weld 71 is then formed in each of the plurality of holes H (S30: first welding step (welding step)). At the first welding step, the welding system 100 causes the filler material feeder 40 to place the filler material 72 inside each of the hole H, cause the laser processing machine 30 to melt the filler material 72 by emitting and scanning with the laser L, so that the hole H is filled with the molten filler material 72.

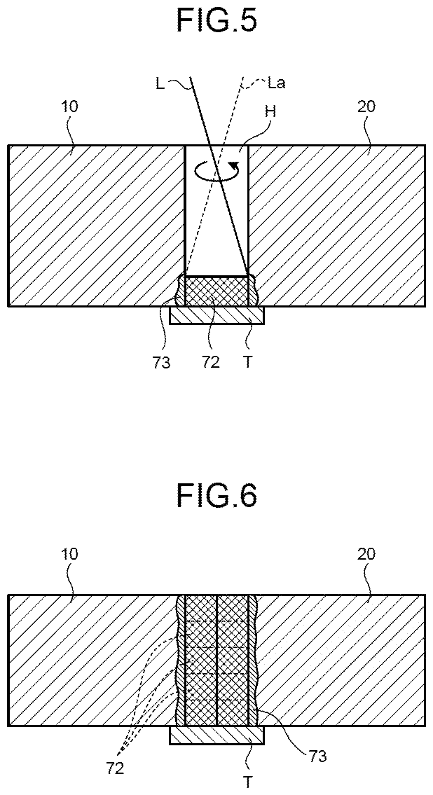

FIGS. 5 and 6 are schematics illustrating structures of the cross-section across the line A-A in FIG. 3 (ST3). In FIGS. 5 and 6, to make the internal structure of the hole H easily identifiable, the hole H is illustrated at an aspect ratio that is different from the actual one. As illustrated in FIGS. 5 and 6, explained in this embodiment is an example in which the hole H is a through-hole passing through the first target member 10 and the second target member 20 in the thickness direction. With such a through hole, a dolly block T is disposed, at steps such as the abutting step, in such a manner that the opening of the hole H on the opposite side of the opening through which the laser L becomes incident (e.g., the opening facing downwards in the drawings) is closed thereby, for example. In this configuration, the filler material feeder 40 places the filler material 72 inside the hole H having the dolly block T placed on the bottom.

After the filler material 72 is placed, the laser processing machine 30 causes the laser emitter device 31 to emit the laser L toward the bottom of the hole H. The laser processing machine 30 irradiates the surface of the filler material 72 placed inside of the hole H with the laser L. The laser scanner device 32 scans the laser L inside the hole H. The laser scanner device 32 scans the position being irradiated with the laser L at a speed of 1 m/sec or higher, using the first Galvano mirror 33 and the second Galvano mirror 34. By setting the interval between the trajectories of the scan, that is, the interval between the positions irradiated with the laser to 1 mm or less, the laser scanner device 32 can suppress spiking of the laser welding. When the laser is a short-pulse laser, the laser emitter device 31 and the laser scanner device 32 irradiate the surface of the filler material 72 with the laser 300 times, for example, while moving the position irradiated thereby following a set pattern.

The filler material 72 is caused to melt by being irradiated with the laser L. The molten filler material 72 is loaded inside and fill the hole H. As illustrated in FIG. 5, by being irradiated with the laser L (La), a penetration portion 73 is formed on the inner circumference of the hole H. The penetration portion 73 is formed around the filler material 72 filled inside the hole H. The penetration portion 73 has an outer diameter of 6 mm or more and 7 mm or less, for example.

At the first welding step, the molten filler material 72 is laid in a plurality of layers in the height direction, as illustrated in FIG. 6. In other words, at the first welding step, the hole H is filled by laying the filler material 72 having molten and then solidified in a plurality of layers in the height direction. The number of layers of the filler material 72 is preferably one or more and 20 or less, for example. In this example, the number of layers in which the filler material 72 is laid is explained to be one or more, but may be in plurality. From the viewpoint of the efficiency, it is more preferable for the number of the layers of the filler material 72 to be smaller. At the first welding step, the weld 71 including the filler material 72 and the penetration portion 73 is formed in each one of the holes H. At the first welding step, the weld 71 is formed for each of the holes H.

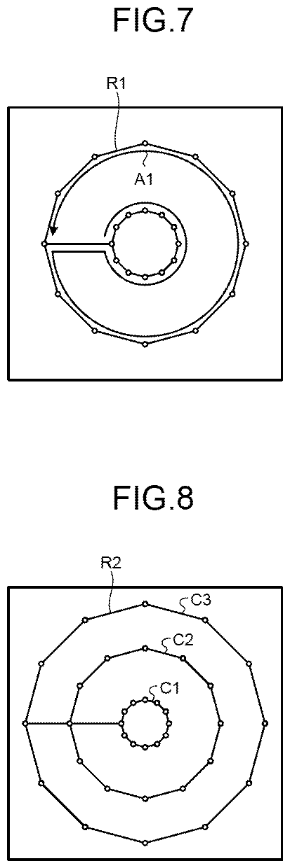

FIGS. 7 to 9 are schematics for explaining examples of a trajectory along which the laser L is scanned. FIGS. 7 to 9 illustrate the hole H in a view from the side of the opening (from the side the laser L becomes incident). The trajectory R1 illustrated in FIG. 7 includes a radially inner circle and a radially outer circle. The laser scanner device 32 can emit laser at each point on the trajectory R1, by moving the position irradiated therewith, in the direction indicated by the arrow A1.

The trajectory R2 illustrated in FIG. 8 has three concentric circles C1, C2, and C3 having diameters that are different from one another in a direction from radially inner side toward the radially outer side. In other words, the trajectory R2 includes triple circles, with each pair of these circles being connected by a connection line extending in the radial direction.

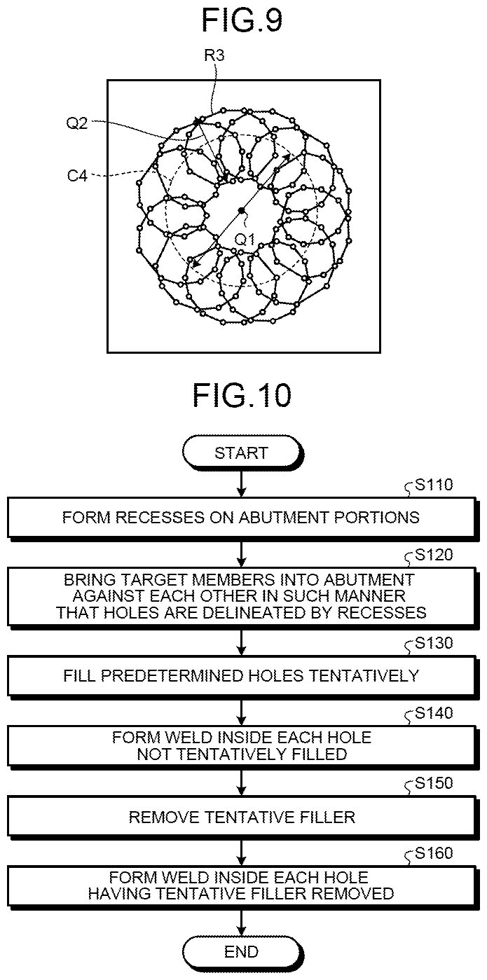

The trajectory R3 illustrated in FIG. 9 is a trajectory resultant of drawing circles at a diameter Q2 while moving the center of the circle defining the trajectory along a reference circle C4 having a diameter Q1. The diameter Q1 is larger than the diameter Q2. By drawing circles while moving the center along the reference circle C4, the filler material is allowed to melt preferably.

By using multiple circles as a pattern along which the laser is scanned, the laser scanner device 32 can control the amount of heat required in each part more appropriately, and allows the filler material 72 to melt continuously using a smaller amount of heat. In this manner, it is possible to suppress defects such as undercuts, and to reduce the heat-affected zone in the welding. When the trajectory delineates multiple circles, the laser is preferably scanned from a circle on the radially inner side toward a circle on the radially outer side. In the explanation above, the trajectory of the laser is explained to include multiple circles, but without limitation thereto, and the trajectory of the laser may delineate a spiral.

It is preferable for the trajectory of the laser to be a trajectory allowing a heat input to be greater toward the outer circumference of the hole, that is, to be greater near the boundary between the hole and the filler material, than that near the center of the hole. In other words, the trajectory of the laser is preferably a trajectory by which the area near the wall is scanned a larger number of times than the area near the center of the hole. For example, in the examples of the trajectory R1 in FIG. 7 and the trajectory R2 in FIG. 8, it is preferable to make the number of operations larger on the radially outer side. In this manner, it is possible to suppress incomplete fusion between the inner circumferential wall of the hole H and the filler material 72, that is, welding defects.

As illustrated in FIG. 4 (ST4), new holes H each spanning across the first target member 10 and the second target member 20 are then formed along the boundary B between the first target member 10 and the second target member 20, each of the new holes being formed between each pair of adjacent holes H (S40: hole forming step). At the hole forming step, holes H that have the same size and shape as those of the holes H may be formed using the hole forming apparatus 60, for example. At the hole forming step, the holes each having a size and a shape that are different from those of the holes H described above may also be formed. In this embodiment, as illustrated in FIG. 4 (ST4), the new holes H are formed in such a manner that some parts of the welds 71 are removed thereby, but without limitation thereto, the new holes H may also be formed in such a manner that the welds 71 are not removed.

As illustrated in FIG. 4 (ST5), a weld 74 is then formed inside each of the new holes H formed at the hole forming step (S50: second welding step (welding step)). At the second welding step, the filler material 75 is disposed inside each of the new holes H, and is irradiated with the laser L to cause the filler material 75 to melt. At the second welding step, the same type of the filler material 75 and the same conditions for emitting the laser L may be used as those at the first welding step. As a result of the second welding step, the filler material 75 is caused to melt, each of the holes H is filled therewith, and a penetration portion 76 is formed around the filler material 75. The penetration portion 76 has an outer diameter of 6 mm or more and 7 mm or less, for example.

At the hole forming step described above, by adjusting the distance between each of the holes H having the weld 71 inside and adjacent one of the holes H that are to be newly formed, it is possible to form a single weld line 70 along the boundary B by connecting the welds 71 and the welds 74 at the second welding step. In other words, by predicting the area of the weld 74 to be formed at the second welding step, the new holes H are formed at the positions where the welds 74 and the weld 71 are to be connected, based on the prediction, at the hole forming step.

In this manner, a weldment W in which the first target member 10 and the second target member 20 are welded with the welds 71, 74 therebetween is achieved. More specifically, the weldment W is a structure resultant of welding the first target member 10 and the second target member 20 along the weld line 70. This weld line 70 is formed along the boundary B between the first target member 10 and the second target member 20 by connecting the welds 71 (the filler material 72 and the penetration portions 73) and the welds 74 (the filler material 75 and the penetration portions 76) in the adjacent holes H.

As described above, the weldment manufacturing method according to the first embodiment includes:
a recess forming step of forming the recesses 12, 22 on the first target member 10 and the second target member 20, the recesses 12, 22 delineating a plurality of holes H each of which spans across the first target member 10 and the second target member 20 and that are arranged along the boundary B between the first target member 10 and the second target member 20, when the first target member 10 and the second target member 20 that are the objects to be welded are brought into abutment against each other;
an abutting step of aligning and bringing the first target member 10 and the second target member 20 into abutment against each other in such a manner that the plurality of holes H are delineated thereby; and
a welding step of forming welds 71, 74 by placing the filler material 72, 75 in the plurality of holes H, irradiating and scanning the filler material 72, 75 with the laser L, to cause the filler material 72, 75 to melt, and the holes H to be filled with the molten filler material 72, 75.

Therefore, because the holes H are filled by placing the filler material 72, 75 in the holes H spanning across the first target member 10 and the second target member 20, and causing the filler material 72, 75 to melt with the laser L, it is possible to weld the first target member 10 to the second target member 20 without providing any groove. In this manner, management of the gap of the groove is rendered unnecessary, and it is possible to suppress weld misalignment. Because the first target member 10 and the second target member 20 are welded in abutment, the holes H are surrounded by a rigid body that is the base material while the holes H are being welded. Therefore, it is possible to suppress welding deformation caused by the molten filler material 72, 75.

In the weldment manufacturing method according to this embodiment, the welding step includes laying the filler material 72 in layers, by repeating the steps of placing the filler material 72 and causing the placed filler material 72 to melt. Therefore, even when the holes H are thin and long, with a high aspect ratio and a small diameter, such holes H can be filled with the filler material 72 efficiently.

In the weldment manufacturing method according to this embodiment, the recess forming step further includes a hole forming step of forming the recesses 12, 22 so as to delineate a plurality of holes H along the boundary B at an interval therebetween, and, after the welding step, forming a new hole H spanning across the first target member 10 and the second target member 20 between each pair of adjacent holes H, the holes being adjacent to each other along the boundary B. The welding step then includes placing the filler material 72 inside the new holes H formed at the hole forming step, and causing the filler material 72 to melt by irradiating the filler material 72 with the laser L. Therefore, by welding the first target member 10 and the second target member 20 incrementally, it is possible to suppress welding deformation.

In the weldment manufacturing method according to this embodiment, the welding step includes forming the penetration portion 73, 76 on the inner circumference of each of the holes H having the filler material 72, 75 placed therein, by irradiating the filler material 72, 75 with the laser L, and the hole forming step includes forming a new hole H between a pair of adjacent holes H at a position where the welds 71, 74 are to be connected at the welding step subsequent to the formation of the new holes H. Therefore, it is possible to form a weld line by connecting the weld 71, 74 between the pairs of adjacent holes H.

### Second Embodiment

A second embodiment of the present disclosure will now be explained. Explained in the first embodiment is an example in which the holes H, each of which is to have the weld 74 formed therein at the second welding step, are formed at the hole forming step subsequent to the first welding step, but the embodiment is not limited thereto. For example, all of the holes may be formed at the recess forming step.

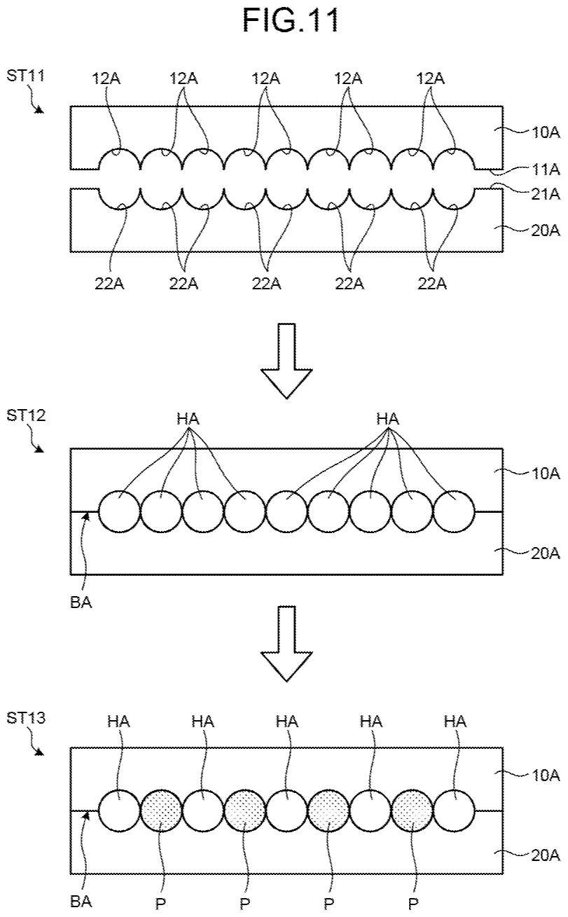

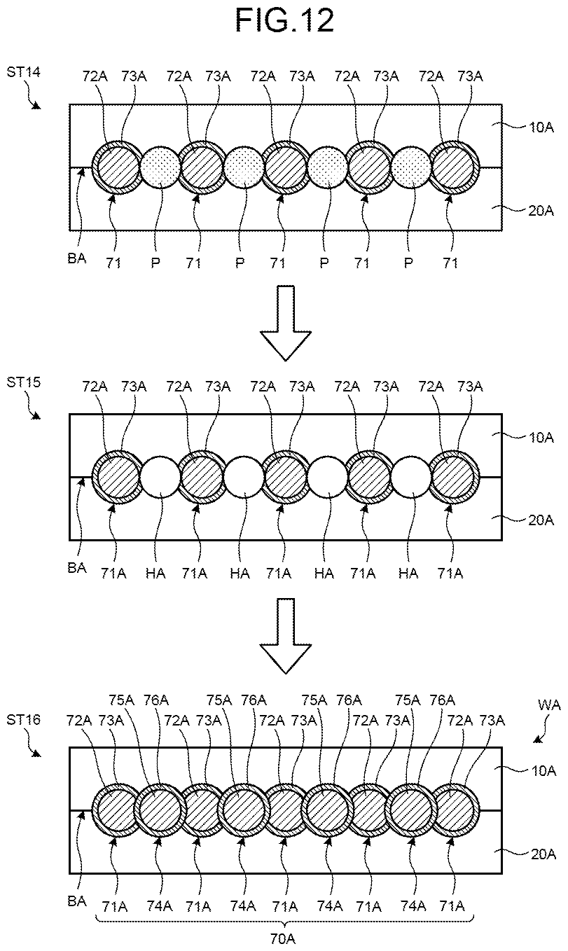

FIG. 10 is a flowchart illustrating an example of the weldment manufacturing method according to the second embodiment. FIGS. 11 and 12 are process charts illustrating steps included in the weldment manufacturing method according to this embodiment.

To begin with, as illustrated in FIG. 11 (ST11), recesses 12A are formed on an abutment portion 11A of a first target member 10A, and recesses 22A are formed on an abutment portion 12A of a second target member 20A (S110: recess forming step). At the recess forming step, the recesses 12A, 22A are formed in such a manner that all of the holes to be used in subsequent steps are formed when the first target member 10 and the second target member 20 that are objects to be welded are brought into abutment. In this embodiment, the recesses 12A and 22A are formed in such a manner that each of the holes has a contact point with another, for example.

As illustrated in FIG. 11 (ST12), the first target member 10A and the second target member 20A are then brought into abutment against with each other (S120: abutting step). At the abutting step, the first target member 10A and the second target member 20A are aligned and brought into abutment against each other so that a plurality of holes HA are delineated by the recesses 12A, 22A, which have been formed at the recess forming step. In this embodiment, each of the holes HA has a contact point with another, for example.

As illustrated in FIG. 11 (ST13), at least one hole HA, among the plurality of holes HA, is filled tentatively (S130: tentative filling step). At the tentative filling step, for example, a tentative filling member P is loaded in every other holes in the row direction, among the plurality of holes HA that are arranged in the row. As the tentative filling member P, a material such as a ceramic that does not melt by being irradiated with the laser L is used.

As illustrated in FIG. 12 (ST14), a weld 71A is then formed inside each of the holes HA not having been tentatively filled (S140: first welding step (welding step)). At the first welding step, the holes HA are filled with the filler material 72A, and the filler material 72 is irradiated with the laser L, thereby causing the filler material 72 to melt, and the holes H are loaded therewith, following the same sequence as that in the first embodiment. A penetration portion 73A is formed around the filler material 72A. In this embodiment, the penetration portion 73A is not formed inside the holes with the tentative filling member P, because the tentative filling member P does not melt.

As illustrated in FIG. 12 (ST15), the tentative filling members P are then removed from the respective holes HA in which the tentative filling members P have been placed (S150: removing step). At the removing step, by removing the tentative filling members P, hollow holes HA are formed. In this embodiment, because the hole HA are through-holes, as an example, the tentative filling members P can be easily removed.

As illustrated in FIG. 12 (ST16), a weld 74A is then formed inside each of the holes HA having the tentative filling members P removed (S160: second welding step (welding step)). At the second welding step, the filler material 75A is disposed inside each of the holes HA having the tentative filling member P removed, and is irradiated with the laser L to cause the filler material 75A to melt. At the second welding step, the same type of the filler material 75A and the same conditions for emitting the laser L may be used as those at the first welding step. As a result of the second welding step, the filler material 75A is caused to melt, each of the holes HA is filled therewith, and a penetration portion 76A is formed around the filler material 75A.

At the recess forming step described above, by adjusting the distance between the adjacent holes HA, it is possible to form a single weld line 70A along the boundary BA by connecting the welds 71A and the welds 74A at the second welding step. In other words, by predicting the areas where the welds 71A, 74A are to be formed at the first welding step and the second welding step, respectively, the recesses 12A, 22A are formed, at the recess forming step, at the positions where the holes HA are to be formed at positions where the welds 71A, 73A are to be connected, based on the prediction.

In this manner, a weldment WA in which the first target member 10A and the second target member 20A are welded with the welds 71A, 74A therebetween is achieved. More specifically, the weldment WA is a structure resultant of welding the first target member 10A and the second target member 20A along the weld line 70A. This weld line 70A is formed along the boundary BA between the first target member 10A and the second target member 20A, by the welds 71A and 74A inside the adjacent respective holes HA becoming connected to each other.

As described above, the weldment manufacturing method according to the second embodiment further includes the tentative filling step of filling at least one hole HA, among the plurality of holes HA, with a tentative filling member P, subsequently to the abutting step, and the welding step includes filling the holes HA not having the tentative filling members P placed therein, among the plurality of holes HA, with the filler material 72A, and irradiating the filler material 72A with laser and causing the filler material 72A to melt. Because the first target member 10 and the second target member 20 are welded in abutment, with the tentative filling members P that are rigid bodies disposed therebetween. Therefore, it is possible to suppress deformation resultant of the welding.

The weldment manufacturing method according to this embodiment further includes the tentative filler removing step of removing, subsequently to the welding step, the tentative filling members P from the hole HA in which the tentative filling member P has been placed, and the welding step includes forming the weld 74A inside the hole HA from which the tentative filling member P has been removed. Therefore, by welding the first target member 10A and the second target member 20A incrementally, it is possible to suppress welding deformation.

In the weldment manufacturing method according to this embodiment, the recess forming step includes forming the recesses 12A, 22A at positions where the holes HA are to be formed at positions where the welds 71A, 74A in the adjacent holes HA are to become connected at the welding step. Therefore, it is possible to form a weld line by connecting the welds 71A, 74A inside the adjacent holes HA.

### Third Embodiment

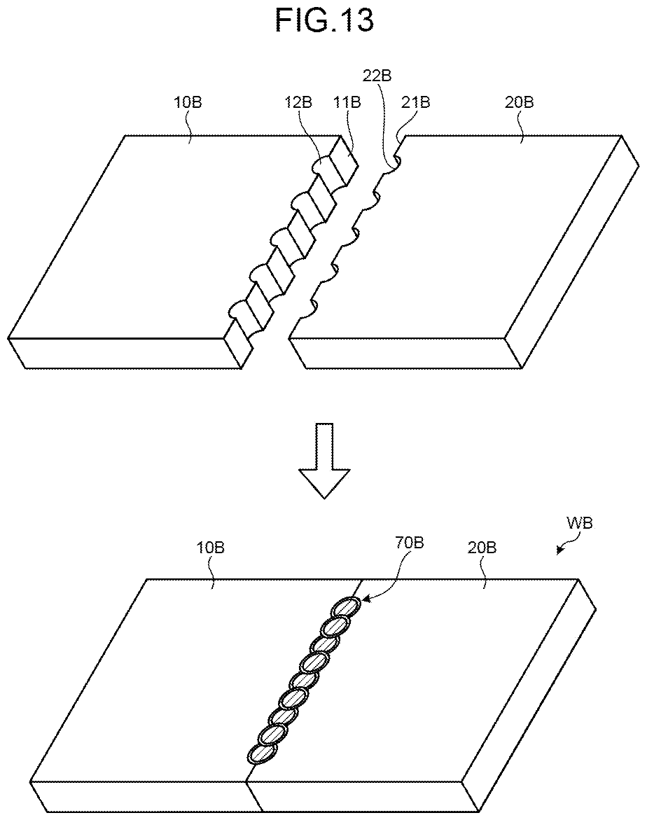

FIG. 13 is a schematic illustrating an example of a weldment manufacturing method according to a third embodiment. In the example illustrated in FIG. 13, a first target member 10B and a second target member 20B that are the objects to be welded are large members that are fabricated with three-dimensional printing. The first target member 10B and the second target member 20B have a thickness of 250 mm or so, for example.

The first target member 10B is designed to have recesses 12B on an abutted end face 11B, for example, and fabricated, based on the design, by three-dimensional printing. In the same manner, the second target member 20B is designed to have recesses 22B on an abutted end face 21B, for example, and fabricated, based on the design, by three-dimensional printing. The recesses 12B and the recesses 22B are designed to be provided at a position where holes HB are to be formed thereby when the first target member 10B and the second target member 20B are brought into abutment, for example.

By welding the first target member 10B and the second target member 20B fabricated in the manner described above using the weldment manufacturing method described in the first embodiment or the second embodiment, a welded object WB is formed. The welded object WB is a structure resultant of welding the first target member 10B and the second target member 20B along the weld line 70B. In the manner described above, the large first target member 10B and second target member 20B can be welded easily and quickly.

Although FIG. 13 illustrates an example in which the welded object is formed by the weldment manufacturing method described in the first embodiment, the embodiment is not limited thereto, and the recesses corresponding to all of the holes may be formed on the first target member 10B and the second target member 20B, as in the welded object manufacturing method described in the second embodiment.

### Fourth Embodiment

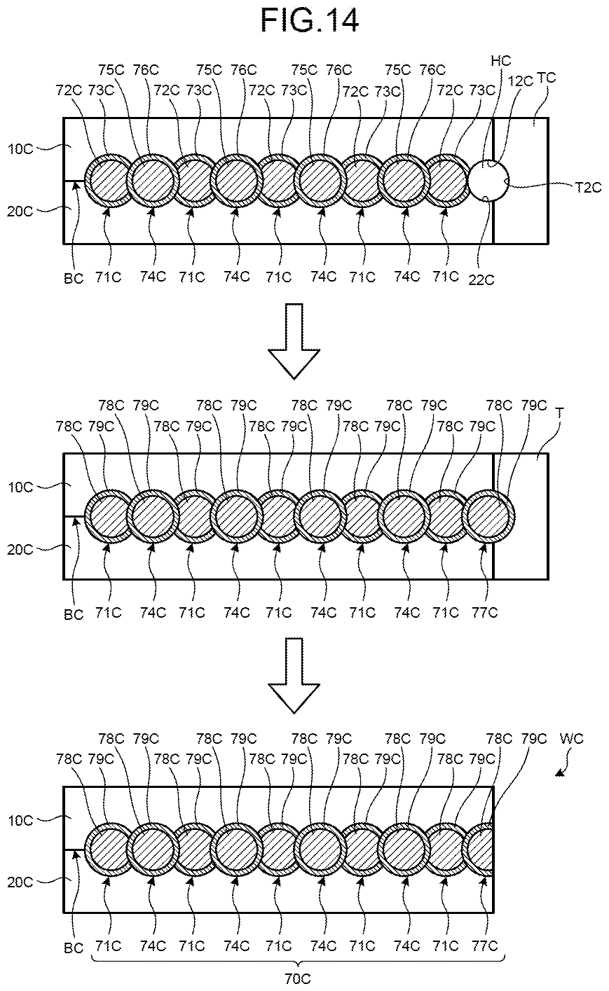

FIG. 14 is a schematic illustrating an example of a weldment manufacturing method according to a fourth embodiment. Explained in the fourth embodiment is an example in which welding is performed with a hole HD formed on one end of a boundary BC between the first target member 10C and the second target member 20C.

As illustrated in FIG. 14, to begin with, after the support member TC is brought into abutment against the first target member 10C and the second target member 20C, from the side of one end of the boundary BC, an end hole HC is formed in a manner spanning across the first target member 10C, the second target member 20C, and a support member TC (end hole forming step). In this example, an arc-shaped recess 12C is formed on the first target member 10C. An arc-shaped recess 22C is also formed on the second target member 20C, the arc shape being vertically symmetrical to the recess 12C with respect to the boundary BC. A recess T2C also having an arc shape is also formed on the support member TC, and this recess, together with the recess 12C and the recess 22C, delineate a circle.

A weld 77C is then formed inside the end hole HC (welding step). At the welding step, filler material 78C is disposed inside the end hole HC, and is irradiated with the laser L to cause the filler material 78C to melt, in the same manner as the first welding step and the second welding step described above. As a result, the filler material 78C is caused to melt, the end hole HC is filled therewith, and a penetration portion 79C is formed around the filler material 78C.

After the weld 77C is formed inside the end hole HC, the support member TC and a part of the weld 77C, the part having been formed on the support member TC are then removed (support member removing step). At the support member removing step, the weld 77C is removed from a side surface of the end of the first target member 10C and a side surface of the end of the second target member 20C. After the support member TC and the like are removed, the end face of the remaining weld 77C may be smoothed out by polishing the end face, for example. Explained in FIG. 14 is an example in which the weld 77C is formed on one end of the boundary BC, but a weld may also be formed on the other end of the boundary BC.

In this manner, a weldment WC in which the first target member 10C and the second target member 20C are welded with the weld 70C therebetween is achieved. In the weldment WC, because the weld 70C is formed on one end of the boundary BC between the first target member 10C and the second target member 20C, the first target member 10C and the second target member 20C can be welded reliably.

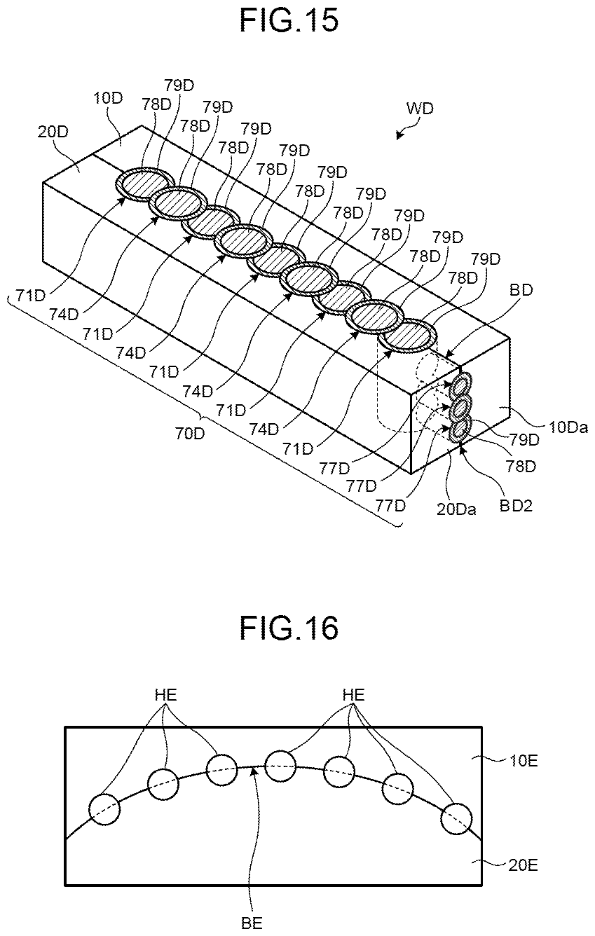

A configuration of the weld formed on one end is not limited to the example illustrated in FIG. 14. FIG. 15 is a schematic illustrating an example of a weldment WD according to a modification. In the weldment WD illustrated in FIG. 15, welds 70D (welds 71D, 74D, filler material 78D, and penetration portions 79D) have the same configuration as that of the weld 70C (the welds 71C, 74C, the filler material 78C, and the penetration portions 79C) according to the fourth embodiment. In the weldment WD illustrated in FIG. 15, a weld 77D having filler material 78D and a penetration portion 79D extends from an end face 10Da of the first target member 10D and an end face 20Da of the second target member 20D to the weld 71D. In this manner, the weld 77D may be formed in the depth direction from the end face 10Da and the end face 20Da, along the boundary BD. In such a case, the weld 77D may be provided in plurality along the boundary BD2 between the end face 10Da and the end face 20Da. One weld 77D may be provided on the boundary BD2.

The technical scope of the present invention is not limited to the embodiments described above, and the embodiments may be changed as appropriate, within the scope not deviating from the scope of the present invention. For example, explained above in the embodiments are examples in which the boundary between the first target member and the second target member delineates a straight line, but the present invention is not limited thereto. FIG. 16 is a schematic illustrating an example of a weldment manufacturing method according to a modification. As illustrated in FIG. 16, a boundary BE between a first target member 10E and a second target member 20E may delineate a curved line. In such a case, by optimizing the shape of the boundary BE delineating a curved line, it is possible to control the welding deformation, as desired.

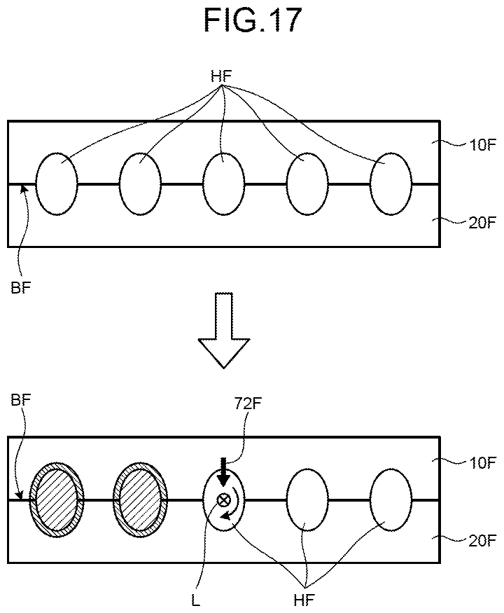

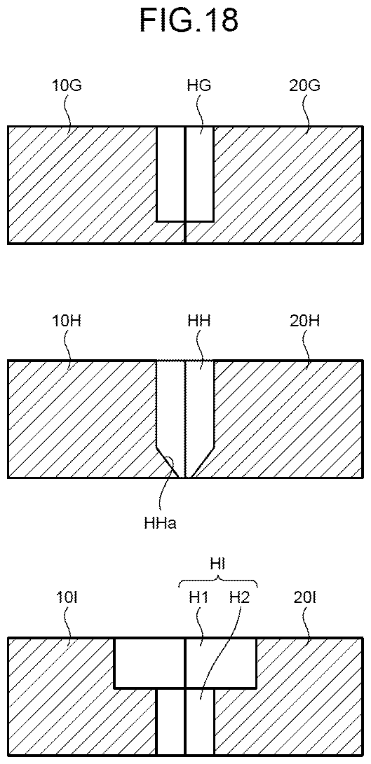

Furthermore, explained above in the embodiments are examples in which the holes spanning across the first target member and the second target member are circular, but the present invention is not limited thereto. FIG. 17 is a schematic illustrating an example of a weldment manufacturing method according to such a modification. As illustrated in FIG. 17, each hole HF spanning across the first target member 10F and the second object 20F may have another shape such as an ellipse. Illustrated in FIG. 17 is an example in which the holes HF are elliptical, but may also be polygonal, e.g., rectangular or triangular, without limitation thereto. By providing the elliptical holes HF with the longitudinal direction thereof laid across the first target member 10F and the second target member 20F, as illustrated in FIG. 17, it is possible to feed a wire-like filler material 72F from one end of the hole HF in the longitudinal direction, while scanning the center of the hole HF with the laser L.

Furthermore, explained above in the embodiments are examples in which the holes spanning across the first target member and the second target member pass through the first target member and the second target member in the thickness direction, but the present invention is not limited thereto. FIG. 18 is a schematic illustrating examples of a weldment manufacturing methods according to some modifications. As illustrated in FIG. 18, each hole HG spanning across a first target member 10G and a second target member 20G may be bottomed, without passing through the first target member 10G and the second target member 20G in the thickness direction. With this configuration, the opening side of the hole HG may be irradiated with the laser. In such a case, full-penetration welding may be performed in a manner penetrating the bottom of the hole HG.

Furthermore, as illustrated in FIG. 18, each hole HH spanning across the first target member 10H and the second object 20H may have a tapered portion HHa on the side of one opening. In this configuration, the side of the opening on the opposite side where tapered portion HHa is provided may be irradiated with the laser. Furthermore, a small-diameter end of the tapered portion HHa of the hole HH may be closed. In such a case, full-penetration welding may be performed in a manner penetrating the closed portion of the tapered portion HHa of the hole HH.

Furthermore, as illustrated in FIG. 18, each hole HI spanning across a first target member 10I and a second object 20I may have incremental diameters that are different in the depth direction. For example, the hole HI has a configuration in which a first hole portion H1 having a larger diameter communicates with a second hole portion H2 having a smaller diameter in the depth direction. Without limitation to the example in which the hole has two different diameters, the hole may have three or more different diameters. The diameters of the hole may also be configured to change gradually.

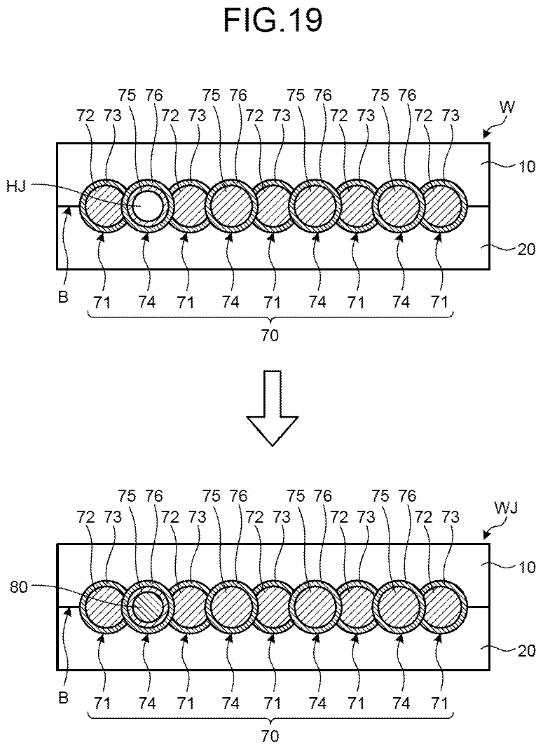

The weldment W achieved by the embodiments described above may also be repaired. A weldment repairing method according to the present disclosure will now be explained. FIG. 19 is a schematic illustrating an example of weldment repairing method according to the present disclosure. Explained herein is an example in which repaired is the weldment W formed by the first embodiment. However, the same explanations are also possible for repairing of the weldments made with the other embodiments.

As illustrated in FIG. 19, to begin with, a repair hole HJ is formed on one of the welds 71 or the welds 74 in the weldment W (a weld 74 in FIG. 19), the one being that is to be repaired. The repair hole HJ may be formed using the hole forming apparatus 60, for example, in the same manner as at the hole forming step in the first embodiment. The repair hole HJ may also be formed using another means. The repair hole HJ is formed inside the hole H formed in the embodiment described above.

A repaired portion (welding repaired portion) 80 is then formed inside the repair hole HJ by welding. At the step of forming repaired portion 80, the repair hole HJ is filled with the filler material, the filler material is irradiated with the laser, thereby causing the filler material to melt, and the hole HJ is loaded therewith, following the same sequence of the welding step described in the first embodiment, for example. The repaired portion 80 including a penetration portion is thus formed around the filler material. In this manner, a repaired weldment WJ including the repaired portion 80 is achieved.

In the manner described above, to repair the welds 71, 74, a repair hole HJ is formed inside of the hole H that is used when the welds 71, 74 are formed, and the repaired portion 80 is formed following the same sequence as that for the weld 71, 74. Therefore, it is possible to suppress welding deformation caused by molten filler material, also at the time of repair.

### REFERENCE SIGNS LIST

11, 12, 12A, 12B, 12C, 22, 22A, 22B, 22C, T2C Recess
10, 10A, 10B, 10C, 10D, 10E, 10F, 10G, 10H, 10I First target member
10Da, 20Da End face
11, 11A, 12, 12A Abutment portion
11B, 21B Abutted end face
20, 20A, 20B, 20C, 20D, 20E, 20F, 20G, 20H, 20I Second target member
20F Second object
22 Laser processing unit
30 Laser processing machine
31 Laser emitter device
32 Laser scanner device
33 First Galvano mirror
34 Second Galvano mirror
40 Filler material feeder
50 Controller
60 Hole forming apparatus
70, 70A, 70B Weld line
70C, 71, 71A, 71E, 73A, 74, 74A, 77C, 77D Weld
72, 72A, 72F, 75, 75A, 78C, 78D Filler material
73, 73A, 76, 76A, 79C, 79D Penetration portion
80 Welding repaired portion
100 Welding system
B, BA, BC, BD, BE Boundary
H, HA, HB, HD, HF, HG, HH, HI Hole
HC End hole
HHa Tapered portion
HJ Repair hole
H1 First hole portion
H2 Second hole portion
L Laser
R1, R2, R3 Trajectory
T Dolly block
TC Support member
W, WA, WC, WD Weldment
WB Welded object

1. A weldment manufacturing method comprising:
forming recesses on a first target member and a second target member, the recesses delineating a plurality of holes each of which spans across the first target member and the second target member and that are arranged along a boundary between the first target member and the second target member when the first target member and the second target member that are objects to be welded together are brought into abutment against each other;
bringing the first target member and the second target member into abutment against each other by aligning the recesses so that the recesses delineate the plurality of holes; and
forming welds by placing filler material in the plurality of holes and irradiating and scanning the filler material with laser to cause the filler material to melt so as to fill the holes with the molten filler material.

2. The weldment manufacturing method according to claim 1, wherein
the forming the recesses includes forming the recesses so that the plurality of holes are delineated with an interval therebetween along the boundary,
the weldment manufacturing method further comprises forming a new hole spanning across the first target member and the second target member, the new hole being formed between holes that are adjacent to each other along the boundary, among the plurality of holes, after forming the welds, and
the forming the welds includes forming a weld inside the new hole.

3. The weldment manufacturing method according to claim 2, wherein the forming the new hole includes forming the new hole at a position at which the welds in the adjacent holes are connected at the forming the welds after the new hole is formed.

4. The weldment manufacturing method according to claim 1, further comprising, after the bringing the first target member and the second target member into abutment against each other, filling at least one hole, among the plurality of holes, with a tentative filling member, wherein
the forming the welds includes placing the filler material inside a hole not having the tentative filling member placed therein, among the plurality of holes, and irradiating the filler material with the laser, to cause the filler material to melt.

5. The weldment manufacturing method according to claim 4, further comprising, after the forming the welds, removing the tentative filling member from the hole having the tentative filling member placed therein, wherein
the forming the welds includes forming a weld inside the hole having the tentative filling member removed.

6. The weldment manufacturing method according to claim 5, wherein the forming the recesses includes forming the recesses so that the holes are formed at a position at which the welds in the adjacent holes are connected at the forming the welds.

7. The weldment manufacturing method according to claim 1, wherein the forming the welds includes laying the filler material in layers by repeating placing the filler material and causing the placed filler material to melt.

8. The weldment manufacturing method according to claim 1, further comprising, with a support member kept in abutment against the first target member and the second target member from a side of an end of the boundary, forming an end hole spanning across the first target member, the second target member, and the support member, wherein
the forming the welds includes forming a weld inside the end hole, and
the weldment manufacturing method further comprises removing the support member and a part of the weld, the part being formed on a side of the support member, after the weld is formed inside the end hole.

9. The weldment manufacturing method according to claim 1, wherein the hole has a depth larger than a diameter.

10. The weldment manufacturing method according to claim 1, wherein an aspect ratio that is a ratio between a diameter and a depth of the hole is substantially 1:20.

11. The weldment manufacturing method according to claim 1, wherein the first target member and the second target member are formed by three-dimensional printing.

12. The weldment manufacturing method according to claim 1, wherein
the forming the recesses includes forming the recesses on an end face of the first target member and an end face of the second target member from a side of one end of the boundary so that the plurality of holes are formed in a direction extending along the boundary, and
the forming the welds includes forming the welds inside the respective holes along the boundary.

13. The weldment manufacturing method according to claim 1, wherein the first target member and the second target member are formed so that the boundary delineates a curved line.

14. The weldment manufacturing method according to claim 1, wherein the hole has an elliptical shape in a view from an axial direction.

15. The weldment manufacturing method according to claim 1, wherein the hole has a bottom in a depth direction.

16. The weldment manufacturing method according to claim 1, wherein the hole or the end hole is formed in a manner passing through in a depth direction, and one opening in the depth direction has a tapered portion.

17. The weldment manufacturing method according to claim 1, wherein the hole or the end hole has a diameter that incrementally changes along a depth direction.

18. A weldment comprising:
a first target member and a second target member; and
a weld that joins the first target member to the second target member, wherein
the first target member and the second target member are in abutment against each other so that a plurality of holes each of which spans across the first target member and the second target member and that are arranged along a boundary between the first target member and the second target member are delineated, and
the weld is disposed so as to fill the plurality of holes.

19. The weldment according to claim 18, wherein the weld includes filler material with which each of the plurality of holes is filled, and a penetration portion that is formed on an inner circumference of the hole, the inner circumference being in contact with the filler material, among the first target member and the second target member, and is disposed so that at least one of the filler material and the penetration portion connects adjacent holes.

20. A weldment repairing method comprising:
forming a repair hole in the weld of the weldment according to claim 18; and
forming a welding repaired portion by placing filler material inside the repair hole, irradiating and scanning the filler material with laser to cause the filler material to melt so as to fill the repair hole with the molten filler material.

21. The weldment manufacturing method according to claim 8, wherein the end hole has a depth larger than a diameter.

22. The weldment manufacturing method according to claim 8, wherein an aspect ratio that is a ratio between a diameter and a depth of the end hole is substantially 1:20.

23. The weldment manufacturing method according to claim 8, wherein the end hole has an elliptical shape in a view from an axial direction.

24. The weldment manufacturing method according to claim 8, wherein the end hole has a bottom in a depth direction.

25. The weldment manufacturing method according to claim 8, wherein the end hole is formed in a manner passing through in a depth direction, and one opening in the depth direction has a tapered portion.

26. The weldment manufacturing method according to claim 8, wherein the end hole has a diameter that incrementally changes along a depth direction.
